(19) United States
(12) Patent Application Publication
(10) Pub. No.: US 2006/0104436 A1
(43) Pub. Date: May 18, 2006

(54) Method of transmitting DSL data over 2 POTS loops

(76) Inventors: Alexander Tesler, Palo Alto, CA (US); Mikhail Korenblioum, Cupertino, CA (US); Michael Troflianin, Cupertino, CA (US)

Correspondence Address: ALEXANDER TESLER, 3731 MIDDLEFIELD ROAD, PALO ALTO, CA, 94303-4715, US

(21) Appl. No.: 11/164,286

(22) Filed: Nov. 17, 2005

Related U.S. Application Data
(60) Provisional application No. 60/522,878, filed on Nov. 17, 2004.

(51) Int. Cl. H04L 5/16; H04M 1/00

(52) U.S. Cl. 379/399.01; 375/222

(57) ABSTRACT

Method of transmitting DSL data over 2 POTS loops providing concurrent operation of 2 telephone lines and one DSL line over up to a 10 km loop.

### BACKGROUND

The present invention relates to data transmission technique and particularity to transmitting ADSL data over a long distance telephone line.

The major limitations that digital data transmission systems faces, operating in the telephone loop plant, are loop attenuation and occurrence of loading coils over a long distance telephone line.

Loop attenuation is mainly determined by wire diameter, loop length and transmitted signal frequency. The most frequently used feeder twisted wire diameter is 0.4 mm for 26-AWG wire.

Based on the ANSI draft document “Spectrum Management for Loop Transmission Systems” an attenuation of 26-AWG filled PIC (plastic insulated cable) cable increases about 9 dB/km at 30 KHz, 14 dB/km at 350 KHz, 15 dB/km at 500 KHz and 22 dB/km at 1 MHz.

DMT based ADSL signals cover bandwidth of 28.875 KHz to 1104 KHz and each sub-carrier is spaced at 4.312 KHz frequency intervals. Sub-carriers 31-255 are reserved for downstream transmission while sub-carriers 0-30 may be assigned for upstream signals. Conventionally transmitted data speed is determined by total Signal to Noise Ratio (SNR). It can be shown that transmission of 80 downstream sub-carriers (bandwidth 200 KHz-500 KHz) with SNR about 28 dB will provide a receiver data rate of approximately 1 Mbit/sec. SNR 28 dB conforms to 80 dB loop attenuation taking in account that transmitted downstream signal power is −30 dBm/Hz and POTS twisted pair noise floor is −140 dBm/Hz as specified in the ITU G.992.1 recommendation. Thus a reach distance of an ADSL system over a 26-AWG POTS telephone line is 80/15 dB/km=5.3 km. This is typical covering area radius in North America, Europe and Asia.

Another special item, concerning capability of the loop plant for digital services is loading coils. At low frequencies a twisted pair acts like a distributed RC circuit and its response drops through the 3 KHz voice band (by as much as 8 dB at 6 km loop and by 13 dB at 9 km loop). That drop reduced the capacity of early telegraphy systems and degraded the voice quality, so Heaviside proposed that lumped inductors be added in series at regular intervals along the loop. A common configuration in the United States is 88 mH coils inserted every 1.8 km.

A 26-AWG loop so loaded is designated 26H88. These loading coils ideally convert a droopy RC network into a maximally flat low pass filter with a cutoff frequency around 3 KHz. In the process of improving voice band response, however, loading coils greatly degrade the response beyond 4 KHz, thus not allowing any broadband services to operate on the loop. The loading coils are a typical problem of rural, lightly populated areas (in USA about 25% of loops are loaded).

Telephone plants throughout the world vary widely in the distribution of their customers (i.e., in percentage of customers covered as a function of distance from the Central Office (CO). It was generally “agreed” that Extended Carrier Serving Area (CSA) with a nominal 18 kft (5.5 km) radius would include about 80% of all customers, assuming that the remaining 20% were typically in rural areas with a lower demand for data services. However, an opposite example is one CO in San Jose (Calif.) with sophisticated “data-hungry” residents which have about 64% of its customers more than 18 kft away.

Several prior arts were focused on the problem of a reach distance extension of digital services.

U.S. Pat. No. 6,927,333 describes the long-distance twisted pair embodiment with substantially decreased loop attenuation. Loop with this invention is made by the following manner (FIG. 1). By means of the introduced ground G1, G2 respectively at the wire 1 at the beginning of the twisted pair and at wire 2 at the end of the twisted pair, the proposed loop is short-circuited by grounds G1 and G2. The grounds G1, G2 is suggested to use the power wire of the AC network with a resistance of the G1-G2 path Rg=10 Ohm.

Along the one half of the bypass line path: a transmitter T over the load-network (H)LN, the one wire 1, and the ground return path G2-G1 of the given pair ends, and the other half of the bypass line path: wire 2, the ground return path G2-G1 of the apposite pair ends, and the load-network (H)LN to receive equipment R it is linked by the distributed capacitance and mutual induction between wires 1,2 with coupling factor k. The object of interest is receiver (H)LN current, it is equal i_{1,2}+i_{G.2}. The wire 2 current i_{1,2} is the wire 1 current i1,G distributed proportionally to Rg, i.e. Rg=0 means, that i_{1,2}+0 as well. Current i_{G,2} is induced by current i_{1,G} through coupling factor k. Due to the fact that distributed capacitance between wire 1 and ground path G2-G1 is many times less than the ones between wires 1,2, the current i_{G,1} comes much larger than the current i_{1,2} of regular twisted pair loop (without G2-G1 ground path). Respectively, current i_{G.2} rises by coupling factor k and as a result the loop attenuation is essentially dropping.

Some practical disadvantages are intrinsic to this invention:
strong frequency and loop length dependence of the coupling factor k, bringing a complicated variable load network/equalizer (H)LN, that should be tuned depending on loop length.
power wire of AC network appears as common return ground path for all digital services of the loop plant resulting in degradation of the receiver SNR and, as an example, in the very beginning of telephone services, aerial distributing wiring has used single non-insulated conductor and earth as return path, but severe crosstalk problems forced the decline of this method of communication.
present technique can not be used on the long-distance loops with loading coils.

In another U.S. Pat. No. 6,507,608 “Multi-line ADSL modulation” a method for delivering data over multiple twisted pairs is given. FIG. 2 illustrates details of communication network comprising a central office ADSL modem (110) designed to drive two lines simultaneously, and additional so-called “phantom” channel by transformers (220, 216, 222), building up common mode of said two lines for transmitting/receiving additional data, twisted pair loops (104, 106), customer premises modem (120) designed to receive two ADSL transmitted signals and to transmit/receive “phantom” channel by transformers (202, 206, 204). Invention contains 14 claims. According to claim 2, ADSL downstream signals are transmitted over first and second twisted pairs and upstream signals are transmitted over additional channel, providing ADSL service to a single Customer Premises Equipment (CPE) device with data rates significantly higher than those associated with single loop transmissions.

Some difficulties associated with the creation and use of a “phantom” channel can exist. Two lines and additional channel have substantially different propagation delays, as differential and common mode use of twisted pair has different distributed parameters.

This problem could be fixed with adaptive signal processing algorithms that are different than those currently in force as a standard.

The present method cannot be used directly with the existing ADSL modem equipments.

This method can't service a long-distance loop plant of more than 18,000 feet because the additional “phantom” channel only works with the two main channels, which are limited by this distance.

This method cannot be used for POTS lines equipped with loading coils.

### SUMMARY OF THE INVENTION

This method provides high speed data service over 2 POTS loops with a reach distance up to 30,000 feet (about 10 km). As mentioned above the twisted pair loop attenuation is a basic restriction for using of 26-AWG feeder cable beyond CSA 18,000 ft.

The only way to reduce attenuation of specified wire diameter twin-wire cable is spacing extension between the wires of twisted pair. Based upon simple computations it can be seen that two wires of the adjacent twisted pairs of 26-AWG feeder cable binder is forming twin-wire line (wire-to-wire loop) with characteristic impedance of about 200 Ohm and an attenuation approximately half of the twisted pair itself. This is the worst case of twisted pairs spacing. Characteristic impedance and attenuation of the wire-to-wire loop asymptotically depends on spacing between twisted pairs. The limit values of the characteristic impedance and attenuation are 600 Ohms and 5 dB/km respectively.

Depending on the spacing of wire-to-wire loop conductors and placement of the twisted pairs within binders or bundles, crosstalk and EMI/RFI concerns may restrict a reach and data speed in some cases. Local Exchange Carrier may need engineering and deployment rules to support digital service within area in question. In any event, due to substantial reduction of loop attenuation the coverage area may be extended beyond 18,000 ft.

To provide wire-to-wire loop by two long distance POTS lines with loading coils, the symmetrical placement of loading coils should be converted to a single wire loading coil arrangement as shown in FIG. 3.

### THE INVENTION DESCRIPTION

First preferred embodiment of the invention is shown on FIG. 4. One terminal of CO ADSL modem is connected through the HPF impedance matching high pass filter simultaneously to both first POTS loop wires 1 and 2. Other terminal connected in the same manner to second POTS loop wires 3 and 4. CPE ADSL modem is connected to both POTS loops in the same matter. Resulting configuration created a virtual DSL loop with each POTS loop playing the role of a single wire of this DSL loop.

HPF impedance matching high pass filters with a cut off frequency about 20 KHz are used to separate voice and data traffic and to match modem impedance to the impedance of the “pair-to-pair” loop.

LPF voice band low pass filter with a cut off frequency of 4 KHz and characteristic impedance of 600 Ohms at pass band, rising thereafter, is used to separate voice and data traffic.

Further voice and data separation in this case is achieved by using the fact that for each of voice POTS loop, DSL signal is a “common mode” signal, that would be rejected due to differential nature of voice transmission over POTS loop. On the other hand, differential signals from wires 1 and 2 (same with wires 3 and 4) will compensate each other at the modem terminals.

Second preferred embodiment is shown on FIG. 5. It is used in the case that POTS loop contains the loading coils. In this case, each POTS loop should be modified as shown on FIG. 3, and then only one, loading coils free wire from each POTS loop is used to form a DSL loop. In this case voice and data traffic separation relies exclusively on frequency filtering by LPFs and HPFs.

Spacing twisted pairs along POTS long distance loop might be changed as a result of twisted pair switching in distribution boxes along route to CPE. This will result in the characteristic impedance of DSL loop changing as well. To avoid reflections along the DSL loop, the impedance matching may be required at cable junction point, as shown on FIG. 6.

Two POTS loops 1-2, 3-4 are redistributed within local distribution box to loops 7-8, 5-6 with different spacing. As a result of it the characteristic impedances Z23 and Z67 are different. High pass filter/impedance matching circuit converts impedance Z23 to impedance Z67 within ADSL DMT frequency range.

Other embodiments are also available, such as combining described above technique with regular twisted pair lines and impedance matching to form a single DSL loop, as shown on FIG. 7.

### BRIEF DESCRIPTION OF THE DRAWINGS

FIG. 1. Block diagram of the twin wire span.

FIG. 2. Local loop with “phantom” channel.

FIG. 3. Converting symmetrical loading coils placement to single wire loading coils arrangement

FIG. 4. Pair-to-pair DSL loop based on two POTS loops

FIG. 5. Wire-to-wire DSL loop based on two POTS loops

FIG. 6a. Junction of the pair-to-pair loop spans with different spacing.

FIG. 6b. Junction of the wire-to-wire loop spans with different spacing.

FIG. 7. Junction with regular twisted pair line.

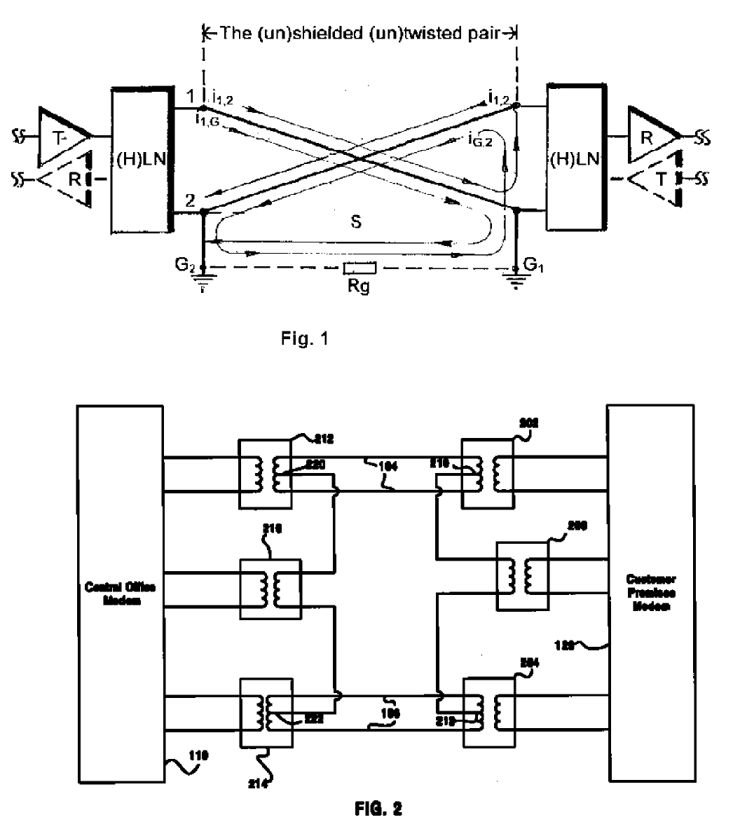

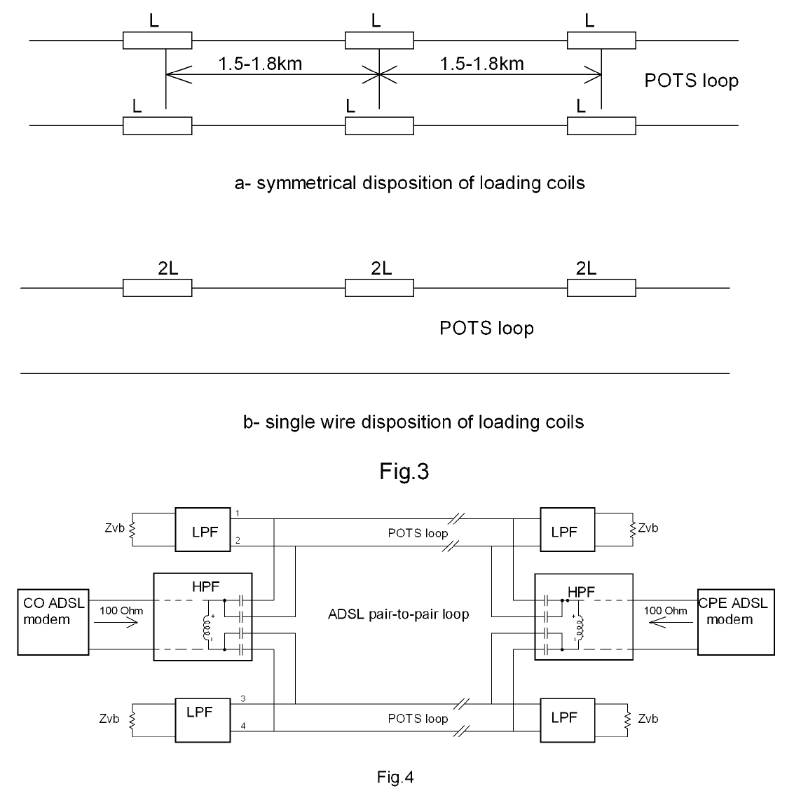

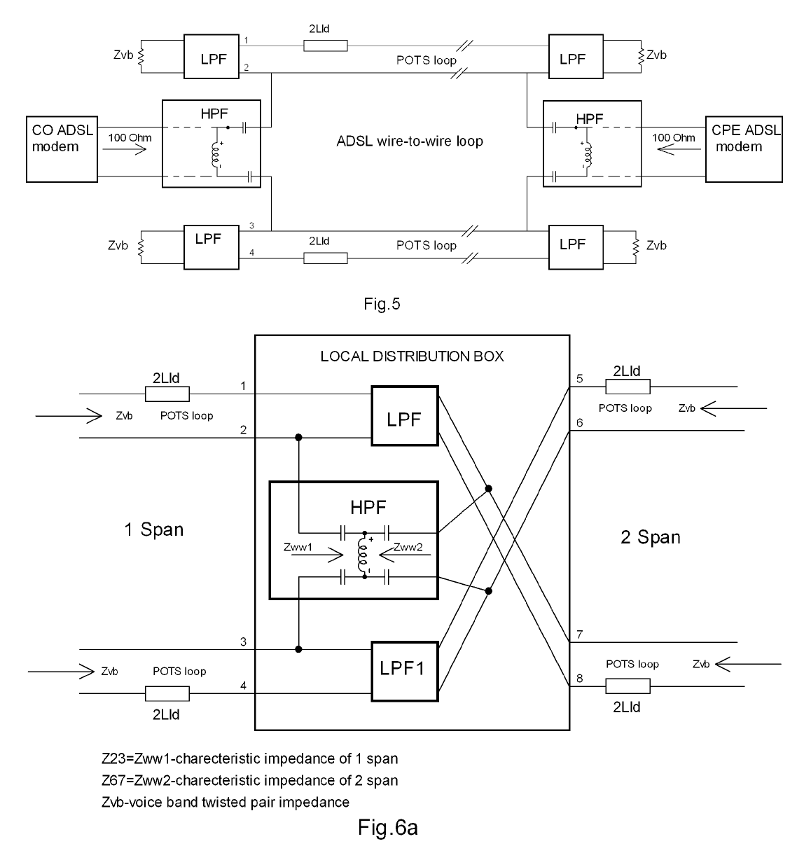

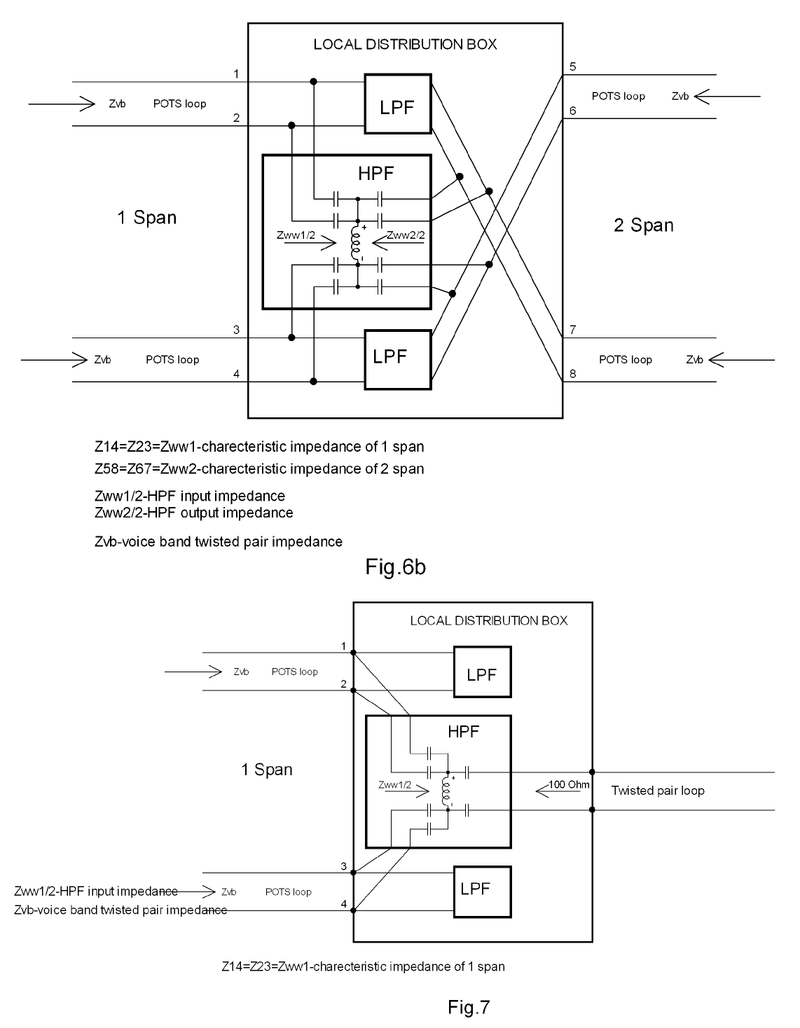

What is claimed is:

1. A method of providing of long-distance digital data service over two POTS lines where:
wires of the first POTS line are used to form a direct path of the cooper loop;
wires of the second POTS line are used to form a return path of the said loop.

2. A method of providing of long-distance digital data service over two POTS lines according to claim 1, comprising of:
transmitting two telephone channels over two POTS loops without loading coils;
transmitting high speed xDSL signal by driving simultaneously both wires of the first POTS line in one direction and driving simultaneously both wires of the second POTS line in the opposite direction.

3. A method of providing of long-distance digital data service over two POTS lines according to claim 1, comprising of:
transmitting two telephone channels over two POTS loops with loading coils;
converting symmetrical loading coils placement in each POTS loop to single wire loading coils arrangement;
transmitting high speed xDSL signal by driving loading-coils-free wire of the first POTS line in one direction and driving loading-coils-free wire of the second POTS line in the opposite direction.

4. A method according to claim 1, where junction of the consecutive POTS line pairs with different spacing and different characteristic impedances is done by means of impedance matching high pass filters within DSL frequency range and 4 KHz low pass filters.

5. A method according to claim 1, where more than one POTS line is used in parallel to form a direct or return path.
